(19) United States
(12) Patent Application Publication
(10) Pub. No.: US 2003/0110210 A1
(43) Pub. Date: Jun. 12, 2003

(54) Information communication system

(76) Inventors: John Simon Nolan, London (GB); Peter Mendel Marks, London (GB); David King Lassman, London (GB)

Correspondence Address: Patent Prosecution Services, Piper Rudnick, 1200 Nineteenth Street N W, Washington, DC, 20036-2412, US

(21) Appl. No.: 10/148,589

(22) PCT Filed: Dec. 4, 2000
(86) PCT No.: PCT/GB00/04643

(30) Foreign Application Priority Data
Dec. 3, 1999 (GB) 99286890

(51) Int. Cl. G06F 15/16; G06F 17/60

(52) U.S. Cl. 709/203; 705/14

(57) ABSTRACT

A method and system for providing on a user computer supplied information from at least one information supplier, the supplied information relating to the primary information displayed via an application in which: (a) the state of the application displaying the primary information to the user is monitored; (b) a context packet derived from the primary information is provided to at least one information supplier; (c) the supplied information from the at least one information supplier, which relates to the primary information is received; and (d) the supplied information is displayed such that it can be viewed by the user simultaneously with the primary information.

### FIELD OF THE INVENTION

The present invention relates to an information communication system. More particularly, it relates to a computer-based information communication system. In a particularly preferred arrangement, it relates to a method of making additional information available to a user of a computer system whereby the additional information provided to the user relates to primary information viewed by the user.

### BACKGROUND

In some network systems, the quantity of information available to the user is vast and thus it can be very time-consuming and frustrating for a user to locate and identify the specific item of information they are seeking.

One extreme example of this is the seemingly endless quantity of information available on the world wide web (WWW) via the Internet. The Internet is a packet switch network which allows data to be routed throughout the WWW. For ease of reference, the information of the world wide web and the systems of the Internet will separately and collectively be referred to as “the Internet”. A portion of the Internet consisting of server computers, also referred to as “sites”, which make data files, which may be multimedia documents, (often referred to as content) generally available for downloading or retrieval by individuals having a computer with Internet access.

The WWW is an aggregate of hypertext documents generally coded in the language Hyper Text Markup Language (HTML), although other languages may be used. These HTML documents support embedded hyperlinks that reference other locations (folder, FTP site, other HTML documents, etc). As discussed above, these hypertext documents are distributed on servers which communicate via the Internet. HTML also allows graphical images to be embedded in HTML documents. Software object components may also be used with HTML documents for displaying content, such as for animation or information processing. Embedded software objects of this type may be in the form of ActiveX Controls, Java Applets or Visual Basic Scripts.

Computer software in general and databases in particular utilise a graphical user interface to provide an environment which allows the user to interact with the operating system on the users computer to input requests, commands etc. The graphical user interfaces are generally icon-driven, menu-driven or include a combination of icon and menu-driven systems. Following the advent of the operating systems sold under the trade name WINDOWS, many systems commonly operate a tile display system. In these tile based systems, the user is provided with specially delineated areas called “windows”, each of which is dedicated to a particular application, programme, file or even document. The technology allows these tiles to be minimised, resized, moved, stacked or even embedded one within another.

To gain access to the Internet, a user will typically connect to an Internet Service Provider (ISP) via a telephone or ISDN modem. Once access has been established, the user can attempt to locate the information in which he is interested. In order to access the documents of the WWW, a user will generally use a web browser program which will be loaded on the user's computer. The user's browser which issues the request for primary information will commonly be presented to the user via a graphical user interface as a tile or window and the resulting primary information returned will be displayed within that window.

Typically, a browser uses the HyperText Transfer Protocol (HTTP). However, other software protocols, such as File Transfer Protocol (FTP), Simple Mail Transfer Protocol (SMTP), Gopher etc may be used.

Generally, information on the Internet is provided as a “page” on a “website”. Each website is assigned an unique address called a URL (Uniform Resource Locator) which is a string that describes the location of a resource on the Internet. A URL may include a number of different components including the identification of the Internet protocol, a server name, and the item path name. Once this URL has been entered into the web browser on the client computer, the browser will make an HTTP request to an Internet server for the website. The server will then respond with the requested information and the content of the page will be displayed for the user by the browser. This transaction has several phases (i.e. Connect, Request, Response, Close). The requested information from the server is most commonly an HTTP file which may include references to other information including audio files and graphical images. During display of the website, the browser will locate the reference to the additional information and will automatically request the additional information from the Internet server which will then be returned to the browser.

Thus, provided that the user knows the URL of the site of interest, he can readily view the site by entering the URL into his browser. Generally this URL will take the user to the home page of the website proprietor. Other pages making up the site can then be accessed by navigation within the site. Large sites often include search mechanisms to enable the user to locate the specific information of interest on the site.

As the Internet has become more widely used and has become more acceptable to the general public, it has evolved from a system used by members of the scientific community to a vehicle for advertising, selling products and services, educating, informing and entertaining. However, many users are not completely at ease using computers or the Internet and it is therefore desirable that the “internet experience” is made as easy as possible.

As indicated above, when a user knows the URL of the site of interest to them, the appropriate site can be located with comparative ease. However, when a user does not know the URL, they must seek out the information required. In general, this will be achieved by use of a search engine. Generally, these search engines enable the user to enter keywords and the search engine will then list sites where the keyword can be found. Whilst this does, on occasion, enable the user to locate the information sought, it is often found that a large number of discrete WebPages is located by the search, which whilst including the keyword, are not actually relevant to the subject of interest to the client. This may be due to the keyword having more than one meaning depending on the context.

Other mechanisms commonly used in combination with web browsers are lists, such as hot lists or history lists. A hot list contains a list of the user's favourite websites. Generally, to view a particular site, the user selects the reference to the website of interest from the hot list. The browser will then, using the stored URL, send the request to a server in the manner indicated above. A history list is similar in concept but is a log of websites that have been visited by the user.

Some browsers also utilise bookmarks. A bookmark is a pointer to a particular website. Again, when a user selects a bookmark, the browser will utilise the URL of the site to access it and display it.

Rather than searching for a particular item of information, a user may wish to browse the information for a particular item of interest. Searching and browsing are related activities. Although in general browsing is less focused. This activity is commonly referred to as “surfing” because of its random nature.

Once the user has located one item of information, whether this be a whole website or a single page on a website, the user may wish to obtain additional information either about the supplier of the website or indeed about the information appearing on the site. However, locating related data in a database, particularly one as vast as the Internet, can be very time consuming and sometimes impossible.

One means of addressing this problem is for website providers to include on their site links to related information. However, such links are selected by the proprietor of the site and therefore do not necessarily provide the user with the information they require. A further disadvantage of this is that their use generally means that the user leaves the first site to go to the new site. Thus the related information cannot be viewed simultaneously.

Whilst a user can add to their hot list reference sites which they might like to access, selecting one of these again generally causes the user to leave the initial site to access the reference site. Thus, it is not usually possible to view the site of interest and the reference site simultaneously.

### SUMMARY OF THE INVENTION

It is a preferred object of the present invention to alleviate or overcome the above-mentioned disadvantages and drawbacks by the provision of an information communication system which provides a user with information which is relevant to the website or the content of the website (or other primary source of information) they have selected and/or are viewing.

It is another preferred object of the invention to provide a system which enables a user of an information source, e.g. a database, such as the Internet, to be supplied with additional information dynamically, which relates to the information which is being viewed by the user.

In the following, the information viewed by the user shall be referred to as “primary information” and the related additional information shall be referred to as “supplied information”

It should also be noted at the outset that whilst the methods and systems of embodiments of the invention are appropriate for use with the Internet, the invention is not limited to this use, and is generally applicable to any information architecture where a primary application displays primary information and there is a desire to display related, supplied information. This is possible with embodiments of the present invention which extract context and request the display of secondary information (i.e. supplied information) relating to the primary information, using the extracted context.

According to a first aspect of the present invention there is provided a method of providing on a user computer supplied information from at least one information supplier, said supplied information relating to primary information viewed by the user via an application (for example a web browser), comprising the steps of:

(a) monitoring the state of the application displaying the primary information to the user,

(b) providing a context packet derived from the primary information to at least one information supplier;

(c) receiving the supplied information from the at least one information supplier, said supplied information relating to said primary information; and

(d) displaying said supplied information such that it can be viewed by the user simultaneously with said primary information.

By this method, the information provided by the at least one information supplier is directly relevant to the primary information being viewed by the user since the supplier has been notified of the primary information (via a context packet) being viewed by the user.

Where said primary information is sought from the Internet, the viewing mechanism will usually be a web browser. The state of the application monitored by the system may be determined by the user's request for primary information, but this is not necessarily the case. The context packet may simply be some identifier of the primary information, for example the URL of a web page, but more preferably includes more contextual information about the content of the displayed information, for example keywords, key phrases, ISBN numbers or other structured data or the like. The nature of the context packet will be determined by the needs of the supplier of the supplied information.

In accordance with a second aspect of the present invention there is provided a computer system for displaying supplied information from at least one information supplier, said supplied information relating to primary information viewed by the user comprising:

(a) an application on a user computer, for requesting, recovering and displaying said primary information;

(b) means for monitoring the primary information displayed by the application;

(c) means for providing a context packet for said primary information to the at least one information supplier, for receiving the supplied information from the at least one information supplier, and for displaying the supplied information such that it can be viewed by the user simultaneously with the primary information.

In order to be able to construct a context packet from the primary information being viewed by the user, the user's computer system may in a preferred arrangement include a conventional browser and a manager browser. The manager browser monitors the information displayed by the primary browser and constructs a context packet based on, but not necessarily limited to,

(a) the URL displayed, and or

(b) keywords and/or phrases in the displayed primary information and/or

(c) the theme of the displayed primary information and/or

(d) other structured data contained in the displayed primary information, for example, but limited to, postcode, ZIP code, ISBN, bar code.

The manager browser then passes this information in a context request via the Internet to the server of the or each supplier of the information such that the suppliers can send back to the manager browser relevant information.

In a preferred form, the suppliers to which the request is sent is determined by the suppliers themselves pre-requesting notification of such information (e.g. supplying a list of keywords that they are interested in). The types of information (identified for instance by specific keywords) which a particular supplier wishes their supplied data to be displayed alongside might typically be selected by each information supplier and notified to the manager browser during connection to a manager server.

The manager browser in addition to analysing the information being viewed in the browser and passing this information to the supplier or each supplier will also preferably serve to display the information provided by the supplier or each supplier.

According to a third aspect of the present invention there is provided a method of displaying information on a user computer having a graphical user interface (e.g. a windows environment), the method comprising the steps of:

(a) providing a graphical user interface;

(b) retrieving supplied information from at least one information supplier; and

(c) displaying said supplied information such that it can be viewed by the user simultaneously with primary information.

In a preferred arrangement the manager browser will commonly be provided as a windows-based application and will appear as a tile window. This tile or window may be separate from the primary browser and will be commonly displayed along side it or, in a preferred arrangement, will be embedded within it. By this means, the user can see the primary information and the supplied information simultaneously.

According to a fourth aspect of the present invention there is provided a computer program recorded on magnetic or optical media for use on a computer comprising code which:

(a) interprets primary information displayed to a user;

(b) transmits context packet requests to the servers of one or more suppliers;

(c) receives supplied information from at least one supplier server; and

(d) displays said information to the user via a graphical user interface.

In a preferred arrangement the manager browser will typically periodically poll the primary browser and interrogate it as to the primary information that is being viewed by the user. If there has been no change to the context derived from the primary information being viewed or the changes are not relevant to the secondary information providers since the last polling, then the manager browser will take no action until the next polling. If, however, the manager browser notes that the context derived from the primary information being displayed by the primary browser has changed and the secondary information provider has indicated that they wish to be notified of this specific change (or of any change) then a context packet that identifies the information will be passed to the at least one supplier.

In an alternative arrangement which does not rely on polling, where such mechanisms are available, the manager browser will be notified by the primary browser of changes in the state of the primary browser.

The polling of the primary application (e.g. the primary browser by the manager browser in the preferred example) may be direct or via suitable software such as a mediator.

It will be appreciated that the present invention relates to an information communication system in which a user may need information from one or more suppliers of supplied information. Alternatively, or additionally, the user may require more than one type of information from a single information supplier.

There are a large number of suppliers or types of suppliers who may advantageously provide information to the user. These may include:

(1) proprietors of electronic encyclopaedia—to provide detailed information relating to the subject of the primary information or of particular items appearing within the primary information.

(2) proprietors of electronic dictionaries—to provide information explaining terms appearing within the primary information or translations of terms in the primary information.

(3) search facilities—to provide lists of additional material relating to aspects of the information viewed.

(4) financial services providers—for example to provide topical information (e.g. analysis, news articles, opportunity to purchase the listed equities relating to listed companies contained within the primary information).

(5) regulatory authorities—to indicate whether the supplier of the primary information complies with various regulatory issues. One example of this would be the Data Protection Registrar in the United Kingdom. Another example would be an authorising agency for secure Internet connections to indicate whether a particular primary site is indeed a secure site for financial transactions.

(6) News agencies—to provide news corresponding to the topics, keywords, key phrases, themes, owners and publishers of the primary information.

(7) Vendors of products—to provide prices, product details, stock status etc of the products mentioned in or related to products or topics in the primary information.

Whilst the above list gives an indication of the variety and scope of the information which could be provided as secondary information, it is by no means exhaustive and it will be understood that any related information may be supplied.

In general, a user will select which information suppliers are of interest to them and will then subscribe to these. Over time, the user may alter their requirements. In the case where a supplier has themselves indicated the types of context they will provide supplied information in response to, the user may select a subset of these types of interest to them.

In a preferred arrangement of the present invention, when the user first connects to the Internet via their browser, modem and ISP, the manager browser will connect via the Internet with a manager server identify the user and verify the services to which they have subscribed. Once this information has been obtained, the manager browser will not normally communicate with the manager server and will communicate with the information suppliers directly rather than via the manager server.

However, in one particular arrangement, the manager server may itself additionally be an information supplier and will therefore be contacted by the manager browser during normal activity as an information supplier rather than as the manager server. One example of information which may be provided via the manager server as an information supplier will be an interactive page at which users can post information relevant to a particular primary site. When a second user views the same primary information site, if they have subscribed to the note service, they will also view the comments posted by the first user and will have an opportunity to add their own comments.

The system may include means to allow the manager server, or the proprietors thereof, to monitor the content of such interactive notes pages, to ensure that none of the information posted is offensive. Notes left which are offensive can then be deleted, obscured or otherwise amended.

It will be understood that, in preferred arrangements, where a large number of possible information suppliers are available to any one user, a user may select to subscribe to more than one supplier of secondary information at any one time. Where this occurs, the display window or tile of the manager browser may comprise a number of individual cells, each of which corresponds to a separate information supplier. Using conventional technology, these cells may resize on receipt of the supplied information so that the best use of the available area is made.

For example, where a user has subscribed to six information suppliers, their manager browser will divide into six discrete cells, which may for example be individually branded. When a request is made to the suppliers for information corresponding to the primary information, one of the suppliers may have a lot of information and another one may have little or indeed nothing to say on the subject. The cells may then automatically, using conventional technology, resize such that the display cell for the supplier with no information may be closed or minimised to a (preferably branded) heading bar identifying the supplier and the cell for the supplier with a lot of information will increase in size such that more of it is immediately visible.

The various cells may also be resized at the command of the user, again using conventional technologies. Where the volume of information provided by the at least one information supplier is greater than can be presented in the available space in the cell, the cell can have a scroll facility such that the user can move through the supplied information.

Where the user has subscribed to a large number of information suppliers, the display in the manager browser may be a menu of supplier servers that have returned information such that the user can select to view some or all of the returned information.

### BRIEF DESCRIPTION OF THE DRAWINGS

The present invention will now be described, by way of example, with reference to the following figures, in which:

FIG. 1 is a schematic diagram of the system of the present invention; and

FIG. 2 is a flow diagram of the polling steps taken by the manager application (e.g. a manager browser).

### DESCRIPTION OF EMBODIMENTS

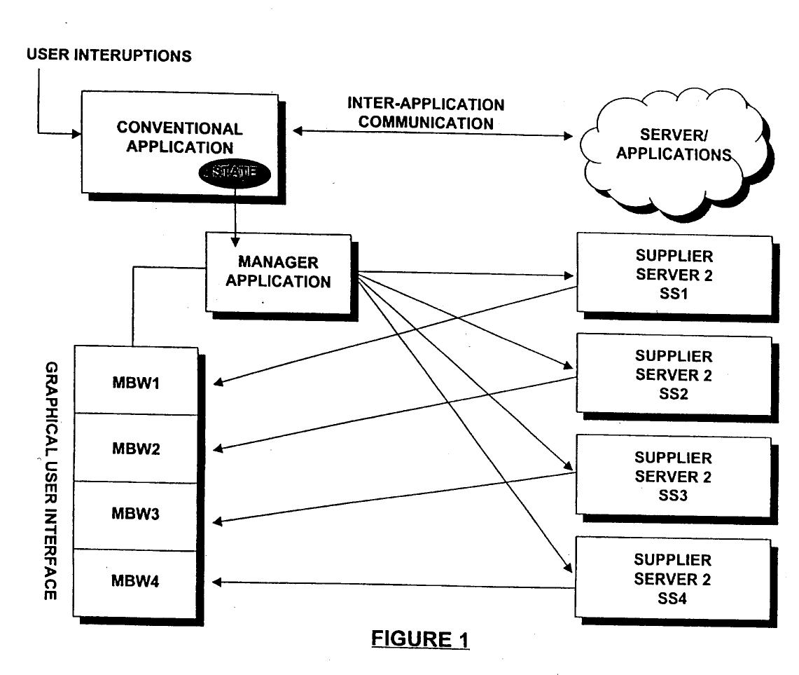

According to the present invention, and as illustrated in FIG. 1, the user's computer includes conventional means for accessing other applications over a Network 2 (such as the Internet). Thus it will include a central processor, an operating system, a modem or other connection to the Network 2 and software known as an Application 1 (such as a browser). For the purposes of the present discussion, this Application 1 will be, referred to as a “conventional application”. The system also includes a manager application 3 (e.g. a manager browser).

When the user connects to the Internet by conventional means, the manager application 3 will contact a manager server (not shown), identify the user and obtain details of the information suppliers to which the user has subscribed. The manager application having obtained this information will disconnect from the manager server unless the manager server is also an information supplier.

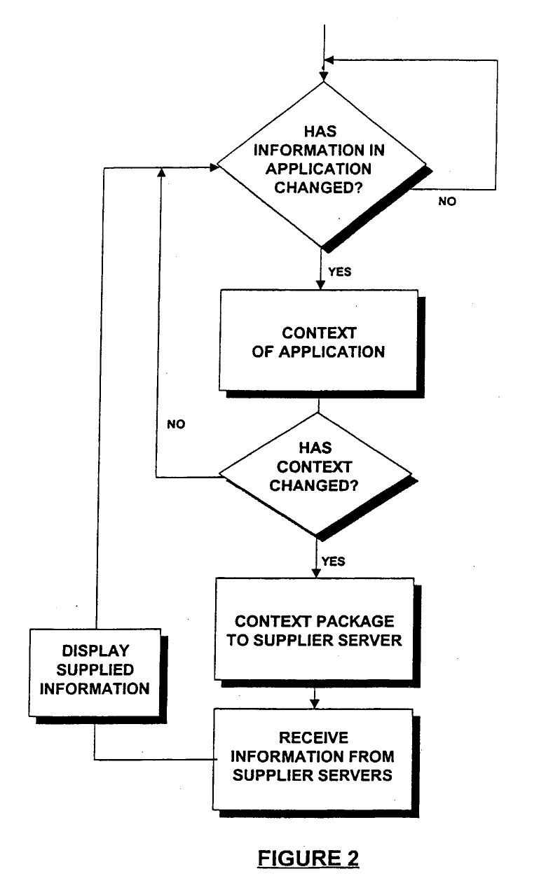

In a preferred arrangement the manager application 3 will then poll the conventional application (e.g. browser) 1 using any suitable technique. As illustrated schematically in FIG. 2, the manager browser will interrogate the conventional application to establish whether the context derived from the state of the application displaying the primary information has changed.

If the derived context has not changed, the manager application 2 will wait before polling the conventional application again. Any suitable polling interval may be selected. If on polling the manager application 3 notes, on the other hand, that the context derived from the conventional application has changed, the manager application will notify the context to one or more supplier servers (SS1 to SS4). The supplier servers will then identify information relevant to the primary information and forward this to the manager application for display to the user, e.g. in a manager browser window.

The supplied information may include the whole content of the relevant information available from any particular supplier, but more desirably the supplied information includes only a summary or some other form of meta-information (e.g. title, headlines, etc) about the relevant information along with a link to the whole content of the information itself. The content and appearance of the supplied information may be controlled by the information supplier.

As previously mentioned, the window of the manager browser (or other user interface for displaying the supplied information) may be divided into cells MBW1 to MBW4 each corresponding to a supplier server SS1 to SS4 such that the information from MBW1 will be displayed in cell MBW1 and so on.

During retrieval of information from the supplier servers, or once the information from the supplier servers has been retrieved and obtained, the manager application will recommence polling of the conventional application.

As already noted above, the context is derived from the state of the conventional application, that is to say the data displayed as primary information. The context may be derived based on any elements of this application state (e.g. any of the data which is displayed on a web page), including for instance some unique identifier of the primary information (for example its URL in the case of a web page) or, more preferably, will be based alternatively or additionally on the actual content of the primary information, e.g. keywords, themes etc.

In this way, the system can operate to provide relevant supplied information independently of a user's interaction with the system. Of course, some changes in the context of the primary information will be consequential to actions of the user, e.g. ‘click-throughs’ or the entering of a new URL, but others may not be, for instance where a user is led automatically through a series of web pages in a slide-show-fashion. The described approach also has the advantage that it can be applied to any form of primary information, so long as the state of the application is such that the system can scan through the primary information displayed to extract context.

By extracting the context in this manner, particularly when it is based on keywords or thematic extraction within the primary information, a great deal of flexibility is provided in terms of which information suppliers will provide supplied information in which circumstances. For instance, it enables the information suppliers themselves to identify the context with which they want their supplied information to be identified.

This may be achieved, for instance, by each information supplier creating their own list of keywords or themes for the context extraction. This list could be updated as frequently or infrequently as the information supplier chooses, under their control.

For example, a supplier of news information may wish to update their list regularly in line with topical news stories.

However, it is not only the information providers who are given flexibility by this approach. The users can also benefit. For instance, in addition to selecting which information providers they wish to receive supplied information from, they can also be given the option of selecting a subset of keywords from any particular suppliers list, to exclude those topics which are of no interest to them. In relation to their choice of information supplier or suppliers, conveniently the user may be presented with a directory from which to choose. Additionally or alternatively, information suppliers not in the directory may be selected separately by the user, e.g. from that supplier's website.

Desirably, the user may also be given the flexibility to order and arrange the identifiers of the various information suppliers they have selected within the graphical interface of the manager application (e.g. browser) in which they are displayed.

Various modifications to the specifically described embodiment are possible without departing from the present invention. For instance, although the discussion of the present invention has been largely directed to the Internet, it will be understood that the problems as identified above and the solution provided by the present invention are equally applicable to any data system including but not limited to, systems such as an intranet, extranet or other networked data sources, including information retrieval systems. It is also the case that the supplied information need not be restricted to pure information and links alone, but might also be an application itself or alternatively the output from an application such as, for example, a spell checker, MP3 player, email notifier, messenger service or SMS text messaging application.

1. A method of providing on a user computer supplied information from at least one information supplier, said supplied information relating to the primary information displayed via an application, comprising the steps of:
(a) monitoring the state of the application displaying the primary information to the user;
(b) providing an context packet derived from the primary information to at least one information supplier;
(c) receiving the supplied information from the at least one information supplier, said supplied information relating to said primary information; and
(d) displaying said supplied information such that it can be viewed by the user simultaneously with said primary information.

2. A computer system for displaying supplied information from at least one information supplier, said supplied information relating to primary information viewed by the user comprising:
(a) an application on a user computer, for displaying said primary information;
(b) means for monitoring the state of the application in which the primary information is displayed;
(c) means for deriving a context packet from the said primary information and to provide it to at least one information supplier, for receiving the supplied information from the at least one information supplier; and for displaying said supplied information such that it can be viewed by the user simultaneously with said primary information.

3. A computer system according to claim 2 wherein said means for deriving a context packet from the primary information and providing it to at least one information supplier, for receiving the supplied information from the at least one information supplier, and for displaying said supplied information is a manager application.

4. A computer system according to claim 2 or 3 wherein the context packet is derived from the state of the application displaying the primary information.

5. A computer system according to any one of claims 2 to 4, wherein said context packet comprises keywords, key phrases, post codes, ISBNs, URLs, domains, or the like.

6. A method of displaying information on a user computer having a graphical user interface including a windows environment, the method comprising the steps of;
(a) providing a graphical user interface;
(b) retrieving supplied information from at least one information supplier; and
(c) displaying said supplied information such that it can be viewed by the user simultaneously with primary information displayed in another window.

7. A method according to claim 6, wherein the graphical user interface is a windows-based application and the supplied information is displayed in a window separate from the window in which the primary information is displayed.

8. A method according to claim 7, wherein the window for the secondary information is displayed along side the window for the primary information.

9. A method according to claim 7, wherein the window for the supplied information is embedded within the window for the primary information.

10. A computer program recorded on magnetic or optical media for use on a computer comprising code which:
(a) interprets the state of an application in which primary information is displayed;
(b) constructs a context packet request based on the context derived from the state of the application in which the primary information is displayed;
(c) transmits said request to the servers of one or more suppliers;
(d) receives supplied information from said at least one supplier server; and
(e) displays said supplied information to the user via a graphical user interface.

11. A computer program according to claim 10, wherein the computer program periodically polls the primary application and interrogates it as to the primary information that is being viewed by the user.

12. A computer program according to claim 11, wherein the polling of the primary browser is carried out via a mediator application.
